(19) United States
(12) Patent Application Publication
(10) Pub. No.: US 2025/0224579 A1
(43) Pub. Date: Jul. 10, 2025

(54) HIGH FIBER DENSITY OPTICAL FIBER CABLE HAVING A TEARABLE LUMEN

(71) Applicant: CORNING RESEARCH & DEVELOPMENT CORPORATION, Corning, NY (US)

(72) Inventors: Michael Alexander Heinz, Berlin (DE); John Richard Jacks, Wellington, OH (US)

(21) Appl. No.: 19/093,798

(22) Filed: Mar. 28, 2025

Related U.S. Application Data
(63) Continuation of application No. PCT/US2023/075331, filed on Sep. 28, 2023.
(60) Provisional application No. 63/413,299, filed on Oct. 5, 2022.

(51) Int. Cl. G02B 6/44

(52) U.S. Cl. CPC G02B 6/4431

(57) ABSTRACT

Provided are embodiments of a lumen. The lumen includes a plurality of optical fibers and a membrane surrounding the plurality of optical fibers. A thickness of the membrane is 50 μm or less. Further, the membrane is made from a polymer composition including a polymer component and a filler component, and the polymer composition includes 30 wt % or less of the filler component. The filler component has a specific surface area of at least 3 m²/g. The lumen may be incorporated into a high fiber density optical fiber cable. Also disclosed are embodiments of a method of forming the lumen and optical fiber cable.

### CROSS-REFERENCE TO RELATED APPLICATIONS

This application is a Continuation of International Application No. PCT/US2023/075331, filed Sep. 28, 2023, which claims the benefit of priority of U.S. Provisional Application No. 63/413,299 filed on Oct. 5, 2022, the content of which is relied upon and incorporated herein by reference in its entirety.

### BACKGROUND OF THE DISCLOSURE

The present disclosure generally relates to optical fiber cables and in particular to optical fiber cables having a high density of optical fibers and minimized free space.

In general, an optical fiber cable needs to carry more optical fibers in order to transmit more optical data, and in order to carry more optical fibers, the size of the optical fiber cable conventionally needed to be increased. The increased size is at least partially the result of free space considerations to avoid macro- and micro-bending attenuation losses. For existing installations, size limitations and duct congestion limit the size of optical fiber cables that can be used without the requirement for significant retrofitting. Thus, it may be desirable to provide optical fiber cables having a higher fiber density (i.e., more fibers per cross-sectional area of the cable) without increasing the cable diameter such that the high fiber density cables can be used in existing ducts. Notwithstanding the desire for increased fiber density, organization and access to the optical fibers needs to be maintained. Conventional buffer tubes provide organization but are also thick and take up substantial space, decreasing fiber density and potentially making access difficult.

### SUMMARY OF THE DISCLOSURE

In one aspect, embodiments of the present disclosure relate to a lumen. The lumen includes a plurality of optical fibers and a membrane surrounding the plurality of optical fibers. A thickness of the membrane is 50 μm or less. Further, the membrane is made from a polymer composition including a polymer component and a filler component, and the polymer composition includes 30 wt % or less of the filler component. The filler component has a specific surface area of at least 3 m²/g.

In another aspect, embodiments of the present disclosure relate to an optical fiber cable. The optical fiber cable includes a cable jacket having an inner surface and an outer surface. The inner surface defines a central bore extending along a longitudinal axis of the optical fiber cable, and the outer surface defines an outermost surface of the optical fiber cable. A plurality of lumens is disposed within the central bore. Each lumen of the plurality of lumens includes a plurality of optical fibers surrounded by a membrane. The membrane has a thickness of 50 μm or less, and the membrane is made from a polymer composition including a polymer component and a filler component. The polymer composition includes 30 wt % or less of the filler component. The plurality of optical fibers of the plurality of lumens has a cumulative tensile rigidity of at least 75% of a tensile rigidity of the optical fiber cable.

In still another aspect, embodiments of the present disclosure relate to a method of preparing an optical fiber cable. In the method, a polymer composition is extruded as a membrane having a thickness of 50 μm or less around a plurality of optical fibers to form a lumen. The polymer composition is made of a polymer component and a filler component, and the polymer composition includes 30 wt % or less of the filler component. A plurality of lumens is stranded together to form a cable core, and a cable jacket is extruded around the cable core.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims.

### BRIEF DESCRIPTION OF THE DRAWINGS

The accompanying drawings are included to provide a further understanding, and are incorporated in and constitute a part of this specification. The drawings illustrate one or more embodiments, and together with the description serve to explain principles and operation of the various embodiments. In the drawings:

FIG. 1 depicts a cross-sectional view of a high fiber density optical fiber cable, according to exemplary embodiments;

FIGS. 2A and 2B depict micrographs of particles that can be used as the filler component of the polymer composition of the lumen membrane, according to exemplary embodiments;

FIG. 3 depicts a graph of the tear strength for a variety of lowly-filled polymer compositions of the lumen membrane, according to exemplary embodiments;

FIG. 4 depicts a graph of the tear strength for lowly-filled polymer compositions according to the present disclosure compared to conventional unfilled and highly-filled polymer compositions; and

FIG. 5 depicts a flow diagram of a method of forming a high fiber density optical fiber cable, according to exemplary embodiments.

### DETAILED DESCRIPTION

Embodiments of the present disclosure relate to a tearable lumen for use in a high fiber density optical fiber cable. In order to fit more optical fibers within a cable while maintaining the same cable size and providing fiber organization, the optical fibers can be arranged in lumens comprised of groups of optical fibers surrounded by thin membranes. To provide accessibility to the optical fibers in the lumens without the need for specialized equipment, the lumens according to the present disclosure are tearable by hand. The inventors have found that the property of being tearable by hand relates in part to the thickness of the membrane but also to the composition of the membrane. In particular, it was determined that a polymer composition containing 30 wt % or less of filler component having small (less than 5 μm), sharp (e.g., cubic) particles was able to provide a balance between lumen strength, lumen processability, and lumen accessibility. These and other aspects and advantages of the disclosed tearable lumen for high fiber density optical fiber cables will be described in greater detail below and in relation to the accompanying figures. These exemplary embodiments are provided by way of illustration, and not by way of limitation.

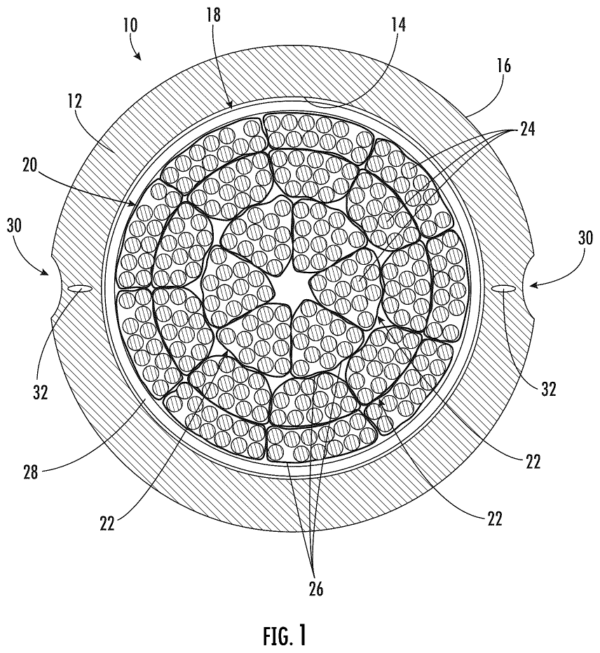

FIG. 1 depicts an example embodiment of a high fiber density optical fiber cable 10. The optical fiber cable 10 includes a cable jacket 12 having an inner surface 14 and an outer surface 16. The inner surface 14 of the optical fiber cable 10 defines a central bore 18 that extends along a longitudinal axis of the optical fiber cable 10. Disposed within the central bore 18 of the optical fiber cable 10 is cable core 20 including a plurality of subunits referred to herein as “lumens” 22. The lumens 22 each include a plurality of optical fibers 24 surrounded by a membrane 26. The membrane 26 is a thin and flexible sheath that allows for the lumen 22 to be reconfigured into a variety of different shapes. In this way, the lumens 22 can be densely packed within the cable core 20 by changing shape, e.g., flattening out, bunching up, or bending, as necessary to fill space within the cable core 20.

In one or more embodiments, the interior surface of the membrane 26 defines an interior cross-sectional area of the lumen 22. The portion of this interior cross-sectional area that is not occupied by the optical fibers 24 is referred to as “free space.” In one or more embodiments, each lumen 22 comprises a free space of 50% or less, 40% or less, 30% or less, or 25% or less. In one or more embodiments, each lumen 22 comprises a free space of 20% or more. Not only does the low free space within the lumens 22 provide a high fiber density for the optical fiber cable 10, but also, the low free space mechanically couples the optical fibers 24 together such that the optical fibers 24 act as a composite strength element within the optical fiber cable 10. In this way, the cable core 20 does not include any additional strength elements, such as glass reinforced plastic rods, steel wires, or tensile strands (e.g., aramid or glass yarns).

In one or more embodiments, the optical fibers 24 take up at least 75%, at least 80%, at least 85%, at least 90%, or at least 95% of the tensile load on the optical fiber cable 10. The amount of tensile load taken up by the optical fibers 24 can be represented by the ratio of tensile rigidity of the optical fibers 24 to the tensile rigidity of the optical fiber cables 10. The tensile rigidity of the optical fibers 24 is the elastic modulus (E) of the optical fibers 24 multiplied by their cumulative cross-sectional area (A) within the optical fiber cable 10. The cumulative cross-sectional area of the optical fibers 24 is the sum of the cross-sectional area of each optical fiber 22 based on the outer diameter of the optical fibers 24. The tensile rigidity of the optical fiber cable 10 is the sum of the products of the elastic moduli (E) of each component of the optical fiber cable 10 multiplied by the component's cross sectional area (A) or cumulative cross-sectional area (A).

In one or more embodiments, the optical fibers 24 comprise a tensile rigidity of at least 30,000 N, at least 35,000 N, or at least 40,000 N for an optical fiber cable 10 having 48 optical fibers 24 and a tensile rigidity of 50,000 N or less. In one or more embodiments, the optical fibers 24 comprise a tensile rigidity of at least 60,000 N, at least 70,000 N, or at least 80,000 N for an optical fiber cable 10 having 96 optical fibers 24 and a tensile rigidity of 100,000 N or less. In one or more embodiments, the optical fibers 24 comprise a tensile rigidity of at least 120,000 N, at least 140,000 N, or at least 160,000 N for an optical fiber cable 10 having 192 optical fibers 24 and a tensile rigidity of 180,000 N or less. In one or more embodiments, the optical fibers 24 comprise a tensile rigidity of at least 175,000 N, at least 200,000 N, or at least 225,000 N for an optical fiber cable 10 having 288 optical fibers 24 and a tensile rigidity of 300,000 N or less. In one or more embodiments, the optical fibers 24 comprise a tensile rigidity of at least 250,000 N, at least 280,000 N, or at least 310,000 N for an optical fiber cable 10 having 384 optical fibers 24 and a tensile rigidity of 350,000 N or less. In one or more embodiments, the optical fibers 24 comprise a tensile rigidity of at least 300,000 N, at least 350,000 N, or at least 400,000 N for an optical fiber cable 10 having 480 optical fibers 24 and a tensile rigidity of 450,000 N or less. In one or more embodiments, the optical fibers 24 comprise a tensile rigidity of at least 375,000 N, at least 425,000 N, or at least 475,000 N for an optical fiber cable 10 having 576 optical fibers 24 and a tensile rigidity of 550,000 N or less.

In one or more embodiments, the optical fibers 24 of the optical fiber cable 10 have the highest elastic modulus of any component in the optical fiber cable 10. In one or more such embodiments, no component in the optical fiber cable 10 besides the optical fibers 24 has a modulus higher than 48 GPa, higher than 40 GPa, higher than 30 GPa, or higher than 25 GPa.

In one or more embodiments, the optical fibers 24 of the cable core 20 of the optical fiber cable 10 comprise at least 50%, at least 60%, at least 70%, at least 75%, at least 80%, at least 85%, at least 90%, or at least 95% of the bending stiffness of the optical fiber cable 10. In an example embodiment, an optical fiber cable 10 having 288 optical fibers 24 organized into lumens 22 exhibited a bending stiffness of 0.51 N·m². The lumens 22 were organized into three layers within the cable core 20 of the optical fiber cable 10 (e.g., as shown in FIG. 1). Of the bending stiffness, the optical fibers 24 accounted for about 0.50 N·m² with the cable jacket 12 accounting for the rest.

As discussed above, the lumens 22 may be stranded (such as SZ-stranded) in the cable core 20 in embodiments. The stranding provides the ability to bend the cable while minimizing tensile and contractive forces within any of the fibers. During cable bending, the optical fibers 24 must be able to shift position, moving longitudinally to relieve those forces so as not to cause attenuation or break the optical fibers 24. Because the membranes 26 and cable core 20 do not provide free space for the optical fibers 24 to increase fiber density by design, the lumens 22 may be configured to move relative to each other in certain embodiments by using solid or gel lubricants, such as talc, or using water-absorbing powders.

Thus, in one or more embodiments, the optical fiber cable 10 may consist essentially of the cable jacket 12 surrounding a plurality of lumens 22. Other components that do not affect the basic and novel characteristics of the optical fiber cable 10 that may be included are, for example, a binder 28 provided between the plurality of lumens 22 and the cable jacket 12, water blocking material (e.g., tapes and powders), lubricants, friction-enhancing materials, and access features (e.g., ripcords or preferential tear features, such as a strip of dissimilar polymer in the cable jacket 12). In one or more embodiments, armor layers and strength elements are excluded from the construction of the optical fiber cable 10.

It is to be appreciated that in some embodiments, the optical fiber cable 10 can include an armor layer or a strength element (not shown). For example, in some embodiments, the optical fiber cable 10 can include strength elements that can be embedded in the jacket to enhance the tensile strength of the optical fiber cable 10. In such embodiments, the optical fibers 24 may take less than 75% of the tensile load on the optical fiber cable 10.

In one or more embodiments, the thickness of the membrane 26 is 50 μm or less, 40 μm or less, 30 μm or less, 25 μm or less, 24 μm or less, 23 μm or less, 22 μm or less, 21 μm or less, 20 μm or less, 19 μm or less, 18 μm or less, 17 μm or less, 16 μm or less, or 15 μm or less. In one or more embodiments, the thickness of the membrane 26 is 5 μm or more, 6 μm or more, 7 μm or more, 8 μm or more, 9 μm or more, or 10 μm or more. In one or more embodiments, the thickness of the membrane 26 is from 5 μm to 50 μm, in particular from 7 μm to 40 μm, and most particularly from 10 μm to 35 μm.

In one or more embodiments, the membrane 26 groups from two to ninety-six in particular from eight to thirty-six, and particularly from twelve to twenty-four, optical fibers 24 into a lumen 22.

In one or more embodiments, the lumens 22 are surrounded by a binder 28. In one or more embodiments, the binder 28 is a thin film jacket having a thickness between 40 microns and 150 microns. In such embodiments, the binder 28 having a thickness in this thickness range reduces the thermal load of the binder 28 on the lumens 22 during extrusion. That is, a thick binder layer could hold enough heat after extrusion to degrade the thin membranes 26 of the lumens 22. In one or more embodiments, the binder 28 is made from, e.g., linear low-density polyethylene (LLDPE).

In one or more embodiments, the cable jacket 12 has a thickness of between 0.5 mm and 1 mm. In particular embodiments, the cable jacket 12 has a thickness that is from 8% to 10% of the outer diameter of the optical fiber cable 10. In one or more embodiments, the cable jacket 12 is made from a polyethylene material (such as high density polyethylene (HDPE)), a low-smoke zero halogen (LSZH) polymer, a filled polyethylene, a flame retardant (FR) polymer, or a urethane polymer, amongst other possibilities.

In one or more embodiments, the cable jacket 12 includes tactile locator features 30. In the embodiment depicted, the tactile locator features 30 comprise diametrically arranged depressions defined by the outer surface 16 of the cable jacket 12. However, in one or more other embodiments, the tactile locator features 30 comprise diametrically arranged bumps defined by the outer surface 16 of the cable jacket 12. The tactile locator features 30 assist a user in opening the cable 10 by guiding the user to the location of access features 32. In the embodiment of the optical fiber cable 10, the access features 32 are strips of dissimilar polymer embedded in the polymer of the cable jacket 12. For example, the cable jacket 12 may substantially comprise polyethylene, and the dissimilar polymer of the access feature 32 may be polypropylene. The immiscibility of polyethylene cable jacket 12 and the polypropylene access features 32 prevents a strong bond from forming between the cable jacket 12 and the access features 32, allowing for a user to tear through the cable jacket 12 in the region of the access features 32. Further, once opened at the access features 32, the cable jacket 12 can be split along its length along the access features 32.

In one or more embodiments, the optical fiber cable 10 includes from 8 to 6912 optical fibers 24, more particularly from 48 to 3456 optical fibers 24, still more particularly from 96 to 1728 optical fibers 24, and yet more particularly from 144 to 576 optical fibers 24. In one or more embodiments, the optical fiber cable 10 has a fiber density of at least 7.5 fibers/mm². The fiber density is measured based on the number of optical fibers 24 per cross-sectional area of the optical fiber cable 10 as measured from the outer surface 16. In one or more embodiments, the fiber density is at least 8 fibers/mm², at least 8.5 fibers/mm², at least 9 fibers/mm², at least 9.5 fibers/mm², at least 10 fibers/mm², at least 10.5 fibers/mm², at least 11 fibers/mm², at least 11.5 fibers/mm², or at least 12 fibers/mm². In one or more embodiments, the fiber density may be up to 17 fibers/mm². Further, in one or more embodiments, the outer diameter of the optical fiber cable 10 as measured at the outer surface 16 is 9 mm or less, 8.5 mm or less, 8 mm or less, 7.5 mm or less, 7 mm or less, 6.75 mm or less, 6.5 mm or less, 6.25 mm or less, 6 mm or less, 5.75 mm or less, 5.5 mm or less, 5.25 mm or less, or 5 mm or less. Further, in one or more embodiments, the outer diameter of the optical fiber cable 10 as measured from the outer surface 16 is at least 2 mm.

In one or more embodiments, the optical fiber cable 10 has a cumulative fiber filling coefficient of at least 50%, at least 60%, at least 65%, or at least 70%. In one or more embodiments, the optical fiber cable 10 has a cumulative fiber filling coefficient of up to 85%. As used herein, the term “cumulative fiber filling coefficient” of an optical-fiber cable 10 refers to the ratio of the sum of the cross-sectional areas of all of the optical fibers 24 within the optical-fiber cable 10 versus the inner cross-sectional area of the optical-fiber cable 10 (i.e., defined by the inner surface 14 of the cable jacket 12 or inner surface of binder 28, if included). The cross-sectional area of each optical fiber 24 is determined based on an outer surface of the optical fiber 24.

In one or more embodiments, the optical fiber cable 10 comprises a free space of at most 50%, at most 42.5%, at most 30%, or at most 25%. In one or more embodiments, the free space of the optical fiber cable 10 is at least 15%. As used herein, the free space is the inverse of cumulative fiber filling coefficient (i.e., 100%-cumulative fiber filling coefficient).

According to embodiments of the present disclosure, the lumens 22 comprise a membrane 26 that is configured to be finger-tearable without damaging the optical fibers 24 within the lumen 22. This property relates to the ability of an installer to access the optical fibers 24 within the lumen 22 without the need for specialized equipment and without damaging the optical fibers 24. While the thickness of the membrane 26 is an important factor affecting the tearability of the lumen 22, the inventors have determined that providing a membrane 26 with a desired thickness alone is not sufficient to provide consistent tearability without damaging the optical fibers 24. In particular, the inventors have found that tearability is a function of crack initiation and propagation. The energy for crack propagation is a function of the elasticity and fracture toughness of the membrane 26, which are both high for thermoplastic materials.

Certain efforts to improve tearability have focused on forming the membrane 26 from a highly-filled polymer composition, such as compositions having from 40 wt % to 60 wt % of a filler component. However, such highly-filled polymer compositions are difficult to process at the desired low thickness of the membrane. In particular, it was found that a highly-filled polymer composition could only be consistently processed to a thickness as low as 60 μm. One reason for the inability to process the membrane to the desired thickness is the agglomeration of particles in the filler component. It has been found that agglomerations of about 10x the size of the particle are easily formed in the filler component, and at typical particle sizes of 1 μm to 3 μm, the agglomerations may be up to 30 μm in size. Further, being highly-filled, the polymer composition tends to have large agglomerations positioned in close proximity, which makes processing the membrane at thicknesses below 50 μm difficult.

According to embodiments of the present disclosure, the polymer composition of the membrane 26 contains 30 wt % or less, in particular 25 wt % or less, or still more particularly 20 wt % or less of a filler component. In various embodiments, additives to improve dispersion quality can be included in the polymer composition of the membrane 26. By way of example, and not limitation, such additives can be or include a silane, a functional copolymer, a stearate, or the like. Further, in one or more embodiments, the particles of the filler component have a median size that no more than 5 μm. In one or more embodiments, the polymer composition is configured to have a tear strength (as measured according to ASTM D1938-19) of 10 mN/mm or less, in particular 9 mN/mm or less, and most particularly 8 mN/mm or less. In one or more embodiments, the tear strength is in a range from 2 mN/mm to 10 mN/mm, in particular 3 mN/mm to 9 mN/mm. Embodiments of the polymer composition for the membrane 26 will be described in greater detail below.

The polymer composition for the membrane 26 includes a polymer component and a filler component. In one or more embodiments, the polymer component comprises one or a blend of polymers having a melting temperature above the melting temperature of the cable jacket 12. For example, if the cable jacket 12 is made of or predominantly made of polyethylene, then the polymer component of the polymer composition is selected to have a melting temperature above that of polyethylene. In one or more embodiments, the polymer component has a melting temperature of at least 130° C., or at least 120° C. In one or more embodiments, the polymer component comprises at least one of polypropylene, polybutylene terephthalate, polyethylene, polystyrene, polycarbonate, or polyester. In one or more embodiments, the polymer component further includes additives such as various processing and performance aids, colorants, or compatibilizers, among other possibilities.

In one or more embodiments, the filler component includes one or more inorganic fillers. In one or more embodiments, the filler component includes particles having a median size (d50) of 5 μm or less, in particular 1 μm or less, more particularly 0.5 μm or less. In one or more embodiments, the filler component includes particles having a median size (d50) in the range of 0.1 μm to 0.5 μm, in particular 0.2 μm to 0.4 μm. The size of the particles in the filler component can also be described in terms of the specific surface area (surface area per gram, m²/g) as measured using the BET method (as adopted in ISO 9277). A higher specific surface area corresponds to a smaller particle size. In one or more embodiments, the specific surface area of the filler component is at least 3 m²/g, at least 5 m²/g, at least 7 m²/g, or at least 10 m²/g. In one or more embodiments, the specific surface area may be up to 20 m²/g.

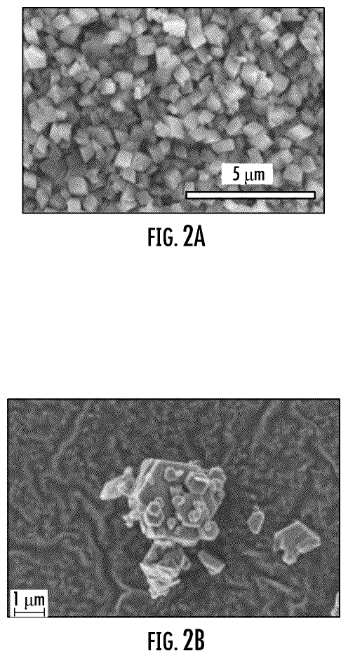

In one or more embodiments, the particles of the filler component have an angular, cubic, prismatic, acicular, or flake morphology. FIGS. 2A and 2B depict examples of particle morphologies for filler component. FIG. 2A depicts an example of boehmite particles. As can be seen, the boehmite particles have a cubic or prismatic morphology. FIG. 2B depicts an example of magnesium dihydroxide particles having a flake morphology. As can be seen, particles having an angular, cubic, prismatic, acicular, or flake morphology provide sharp edges to promote crack growth during tearing of the membrane 26. In particular, the critical stress intensity factor K_{IC} is used to predict the stress state at the tip of a crack (i.e., tear) in the membrane, and the critical stress intensity factor K_{IC} can be modeled using the following equation:

$${K}_{IC} = {σ ( π {a}_{c} )}^{1 / 2} Y$$

in which σ is the stress at the tip of the crack, a_{c} is the critical crack length, and, and Y is a geometry factor. The addition of a filler component decreases the critical crack length a_{c} in the membrane 26, specifically the length through which the crack (i.e., tear) must propagate through the polymer component. For a constant stress σ, the stress intensity factor K_{IC} can be increased by adjusting the geometry factor Y by using sharper particles.

In one or more embodiments, the filler component comprises an inorganic particle, such as one or more of boehmite, magnesium dihydroxide (MDH), aluminium trihydroxide (ATH), talc, calcium carbonate, silica, wollastonite, clay, or mica.

Samples of the membrane 26 for the lumen 22 were prepared and tested for tear strength according to ASTM D1938-19 against conventional materials, including unfilled polymer, highly-filled polymer, and large particle filled polymers. In particular samples of Achieve™ polypropylene (available from Exxon Mobile Corporation, Irving, Texas) were filled with various amounts of coated MDH, MDH, or bochmite. A first set of samples was prepared using coated MDH having a specific surface area of 5 m²/g and filler levels of 5 wt %, 10 wt %, and 20 wt %. A sample was prepared using MDH (uncoated) having a specific surface area of 5 m²/g and a filler level of 20 wt %. Another set of samples was prepared using bochmite having a specific surface area of 3 m²/g and filler levels of 5 wt %, 10 wt %, and 20 wt %. A final set of samples was prepared using bochmite having a specific surface area of 17 m²/g and filler levels of 5 wt %, 10 wt %, and 20 wt %. These samples were tested for tear strength against a sample of unfilled polypropylene (Achieve™) and a highly-filled flame retardant polymer composition based on polypropylene filled with about 60 wt % of MDH.

FIG. 3 depicts a graph of the tear strength for the lowly-filled polymer compositions according to the present disclosure. As can be seen, the coated MDH, MDH, and large bochmite all had a similar tear strength of between about 8.5 mN/mm and 9 mN/mm at 20 wt % fill level. The large bochmite performed better at the 10 wt % and 5 wt % fill levels (about 10 mN/mm and about 11.5 mN/mm, respectively) than the coated MDH (about 11 mN/mm and about 12 mN/mm, respectively). The small bochmite performed the best of the lowly-filled samples. In particular, at the 5 wt % fill level the tear strength was below 8 mN/mm, and at the 10 wt % fill level the tear strength was about 7 mN/mm. At the 20 wt % fill level, the tear strength was as low as about 5 mN/mm. Thus, from FIG. 3, it can be seen that the smaller particle size of the filler component contributes to a lower tear strength.

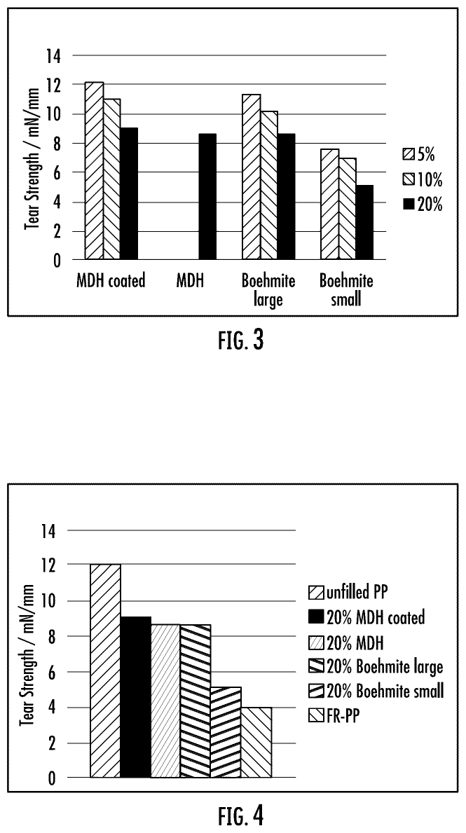

FIG. 4 depicts a graph of the tear strength for the lowly-filled polymer compositions as compared to conventional materials, including the unfilled polypropylene (unfilled PP) and a highly-filled flame retardant polymer composition (FR-PP). As can be seen, the unfilled polypropylene had the highest tear strength at about 12 mN/mm. As mentioned above, the tear strengths for the 20 wt % fill levels of coated MDH, MDH, and large bochmite were similar at about 8.5 mN/mm to about 9 mN/mm. As was also mentioned above, the small bochmite had a tear strength of about 5 mN/mm. The highly-filled flame retardant polymer composition had the lowest tear strength at about 4 mN/mm.

However, as discussed above, such highly-filled polymer compositions cannot be processed to the desired low thickness of 50 μm or less.

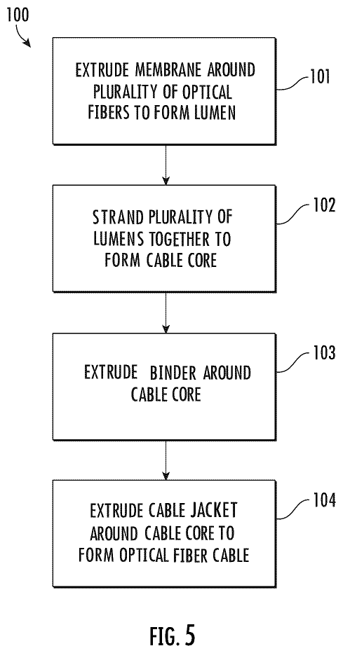

Having described the optical fiber cable 10 and embodiments of a polymer composition for forming the membrane 26, embodiments of a method 100 for manufacturing an optical fiber cable 10 including a plurality of lumens 22 will be described in relation to the flow diagram of FIG. 5. In one or more embodiments, the method 100 of forming the lumens 22 involves extruding the membrane 26 around the plurality of optical fibers 24 in a first step 101. In one or more embodiments, for a twelve-fiber lumen 22, the membrane 26 may be extruded around the optical fibers 24 while the optical fibers 24 are in a 3×4 rectangular or offset rectangular arrangement or a 2×6 rectangular or parallelogram arrangement. In these initial configurations, the lumens 22 may be able to more easily shift to the various space-saving configurations, such as those shown in FIG. 1, to provide a high fiber density optical fiber cable 10.

In one or more embodiments of the method 100, the lumens 22 are formed into a cable core 20 in a second step 102. In embodiments, the lumens 22 extend straight along the longitudinal axis of the optical fiber cable 10 in the cable core 20, and in other embodiments, the lumens 22 are stranded (e.g., S-stranded, Z-stranded, or SZ-stranded) along the longitudinal axis in the cable core 20.

In one or more embodiments of the method 100, the binder 28 is optionally extruded around a plurality of lumens 22 in a third step 103. In a fourth step 104 of the method 100, a cable jacket 12 is then extruded around the lumens 22 or binder 28, as the case may be. During extrusion of the cable jacket 12, the access feature 32 and the tactile locator features 30 may be formed in the cable jacket 12 through the use of specially-configured extrusion die-heads. A vacuum may be pulled during extrusion of the cable jacket 12, which squeezes the cable jacket 12 down around the lumens 22. Additionally or alternatively, the cable jacket 12 can be made thicker, which results in greater shrinkage during cooling, compressing the lumens 22. Advantageously, by compressing the cable jacket 12 around the lumens 22, the individual lumens 22 may be manufactured with a higher than desired free space, and the force of the cable jacket 12 on the lumens 22 in the cable core 20 can reconfigure the lumens 22 into shapes with lower free space within the optical fiber cable 10.

Thus, advantageously, the presently disclosed polymer composition for the membrane 26 provides several processing and performance advantages. In particular, the low level (30 wt % or less) of small particle (median size of 5 μm or less) filler component in the polymer composition allows for the polymer composition to be extruded to thicknesses of 50 μm or less. Further, the extrusion can be performed at typical processing speeds without degrading the membrane quality. Additionally, by using a high melting temperature polymer component the membrane does not stick to the cable jacket 12 when the cable jacket 12 is extruded around lumens 22. Still further, the polymer composition of the membrane 26 is has sufficient mechanical integrity for stranding in the cable core 20 as opposed to highly-filled polymer compositions, which even at greater thicknesses, tend to break at the tensions associated with stranding. Accordingly, the presently disclosed membrane polymer composition achieves desired tearability for ease of access by a cable installer while also having sufficiently robust mechanical properties for manufacturability and processability.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A lumen, comprising:
a plurality of optical fibers;
a membrane surrounding the plurality of optical fibers;
wherein a thickness of the membrane is 50 μm or less;
wherein the membrane comprises a polymer composition comprising a polymer component and a filler component, the polymer composition comprising 30 wt % or less of the filler component;
wherein the filler component comprises a specific surface area of at least 3 m²/g.

2. The lumen of claim 1, wherein the membrane has a tear strength of 10 mN/mm or less as measured according to ASTM D1938-19.

3. The lumen of claim 1, wherein the filler component comprises particles having a median particle size d50 of 5 μm or less.

4. The lumen of claim 1, wherein the filler component comprises particles having at least one of an angular, a cubic, a prismatic, an acicular, or a flake morphology.

5. The lumen of claim 1, wherein the polymer component comprises one or more polymers having a melting temperature of at least 120° C.

6. The lumen of claim 1, wherein the polymer component comprises at least one of polypropylene, polybutylene terephthalate, polyethylene, polystyrene, polycarbonate, or polyester.

7. The lumen of claim 1, wherein the lumen comprises a free space of 50% or less.

8. The lumen of claim 1, wherein the filler component comprises at least one of boehmite, magnesium dihydroxide, aluminium trihydroxide, talc, calcium carbonate, silica, wollastonite, clay, or mica.

9. An optical fiber cable, comprising:
a cable jacket comprising an inner surface and an outer surface, wherein the inner surface defines a central bore extending along a longitudinal axis of the optical fiber cable and the outer surface defines an outermost surface of the optical fiber cable;
a plurality of lumens disposed within the central bore;
wherein each lumen of the plurality of lumens comprises a plurality of optical fibers surrounded by a membrane;
wherein the membrane has a thickness of 50 μm or less;
wherein the membrane comprises a polymer composition comprising a polymer component and a filler component, the polymer composition comprising 30 wt % or less of the filler component; and
wherein the plurality of optical fibers of the plurality of lumens comprises a cumulative tensile rigidity of at least 75% of a tensile rigidity of the optical fiber cable.

10. The optical fiber cable of claim 9, wherein the membrane has a tear strength of 10 mN/mm or less as measured according to ASTM D1938-19.

11. The optical fiber cable of claim 9, wherein the filler component comprises particles having a median particle size d50 of 5 μm or less.

12. The optical fiber cable of claim 9, wherein the filler component comprises particles having at least one of an angular, a cubic, a prismatic, an acicular, or a flake morphology.

13. The optical fiber cable of claim 9, wherein the cable jacket comprises a first polymer and the polymer component of the polymer composition comprises a second polymer, the second polymer having a higher melting temperature than the first polymer.

14. The optical fiber cable of claim 13, wherein the second polymer comprises a melting temperature of at least 120° C.

15. The optical fiber cable of claim 9, wherein the polymer component comprises at least one of polypropylene, polybutylene terephthalate, polyethylene, polystyrene, polycarbonate, or polyester.

16. The optical fiber cable of claim 9, wherein at least one lumen of the plurality of lumens comprises a free space of 50% or less.

17. The optical fiber cable of claim 9, wherein the filler component comprises at least one of boehmite, magnesium dihydroxide, aluminium trihydroxide, talc, calcium carbonate, silica, wollastonite, clay, or mica.

18. The optical fiber cable of claim 9, wherein the outer surface of the cable jacket defines a cross-sectional area perpendicular to the longitudinal axis and wherein the optical fiber cable comprises a fiber density of at least 7.5 fibers/mm² as measured at the cross-sectional area.

19. The optical fiber cable of claim 9, wherein the plurality of optical fibers comprises a highest elastic modulus of any component in the optical fiber cable.

20. The optical fiber cable of claim 9, wherein the filler component comprises a specific surface area of at least 3 m²/g.
